(19) United States
(12) Patent Application Publication
(10) Pub. No.: US 2003/0081765 A1
(43) Pub. Date: May 1, 2003

(54) Mobile terminal having hinge device with LCD

(75) Inventors: Oh Sung Kwon, Seoul (KR); Byung Ju Kim, Seoul (KR)

Correspondence Address: FLESHNER & KIM, LLP, 14500 AVION PARKWAY, SUITE 125, CHANTILLY, VA, 20151, US

(73) Assignee: LG Electronics Inc.

(21) Appl. No.: 10/252,411

(22) Filed: Sep. 24, 2002

(30) Foreign Application Priority Data
Oct. 25, 2001 (KR) 66054/2001

(51) Int. Cl. H04M 1/00; H04M 9/00; H04B 1/38

(52) U.S. Cl. 379/419; 455/90

(57) ABSTRACT

A mobile terminal is provided which includes a terminal main body, a folder having a main LCD mounted thereon, and a hinge device for combining the folder with a main body and having a sub-LCD mounted thereon. While using the main LCD, a user can check the terminal state. In addition, the sub-LCD can be used regardless of whether the folder is opened or closed, so that display efficiency can be maximized. Moreover, since the main LCD and the sub-LCD are mounted at different positions, a thickness of the terminal can be effectively reduced.

### BACKGROUND OF THE INVENTION

1. Field of the Invention

The invention relates to a mobile communication terminal. More particularly, the invention relates to a mobile terminal having an external liquid crystal display (LCD) mounted at a hinge device.

2. Background of the Related Art

A conventional dual-folder type mobile communication terminal is shown in FIGS. 1 and 2. The conventional mobile communication terminal of FIGS. 1 and 2 has external and internal LCDs 1 and 2 mounted on a front face and a rear face of a folder 10. In order to open and close the folder, a hinge 3 is positioned at the center of a hinge device. The mobile terminal with this structure has many advantages, including that the state of the terminal (i.e, a reception sensitivity, a battery residual amount, time, and receipt of a new message, etc.) or a character message can be checked via the external (sub) LCD 1 without opening the folder 10, so it is widely adopted these days.

However, the conventional terminal of FIGS. 1 and 2 has the disadvantage that the external LCD 1 is not utilized in a state that the folder 10 is opened. For example, if a user intends to check the time while he or she is sending a short message using the internal LCD 2, the user must turn the mobile terminal over, which is very inconvenient. Thus, with a terminal having this structure, it is impossible for the user to check the state of the terminal through the external (sub) LCD while simultaneously using the internal (main) LCD.

In addition, the conventional mobile terminal of FIGS. 1 and 2 has the disadvantage that the LCDs must be mounted at the same position on the front face and the rear face of the folder, so that the terminal is thick, which is not favorable as the need is for a compact and light-weight terminal.

### SUMMARY OF THE INVENTION

An object of the invention is to solve at least the above problems and/or disadvantages and to provide at least the advantages described hereinafter.

Therefore, an object of the invention is to provide a dual-folder type mobile terminal having improved display efficiency.

Another object of the invention is to provide a dual-folder type mobile terminal having a reduced thickness in comparison to prior art terminals.

In order to achieve at least the above objects in whole or in part and in accordance with the purposes of the invention, as embodied and broadly described herein, a mobile terminal according to an embodiment of the invention is provided which includes a terminal main body, a folder with the main LCD mounted thereon, and a hinge device for combining the folder with a main body and having a sub-LCD mounted at a predetermined position thereon. In the mobile terminal according to an embodiment of the invention, the hinge device may include a hinge mounted on the holder, a hinge combining unit including a sub-LCD, and a rotational shaft for coupling the hinge and the hinge combining unit.

To further achieve at least the above objects in whole or in part and in accordance with the purposes of the invention, as embodied and broadly described herein, a mobile terminal according to an embodiment of the invention is provided which includes a terminal main body, a folder with a main LCD mounted thereon, and a hinge device, wherein the hinge device comprising a hinge mounted on the folder, a hinge combining unit having a sub-LCD, and a rotational shaft for coupling the hinge and the hinge combining unit.

To further achieve at least the above objects in whole or in part and in accordance with the purposes of the invention, as embodied and broadly described herein, a mobile terminal according to an embodiment of the invention is provided which includes a main body, a cover attached to the main body, a first display mounted on the cover, and a second display configured to be viewable whether the cover is opened or closed.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements. The accompanying drawings, which are included to provide a further understanding of the invention and are incorporated in and constitute a part of this specification, illustrate embodiments of the invention and together with the description serve to explain the principles of the invention.

In the drawings:

FIG. 1 is a front view of a conventional dual-folder type mobile terminal, in a closed state;

FIG. 2 is a side perspective view of a conventional dual-folder type mobile terminal, in an open state;

FIG. 3 is a conceptual plane view of a mobile terminal in accordance with an embodiment of the invention;

FIG. 4 is a side perspective view of a mobile terminal in accordance with an embodiment of the invention, in a closed state; and

FIG. 5 is a side perspective view of a mobile terminal in accordance with an embodiment of the invention, in an opened state.

### DETAILED DESCRIPTION OF PREFERRED EMBODIMENTS

Reference will now be made in detail to preferred embodiments of the invention, examples of which are illustrated in the accompanying drawings.

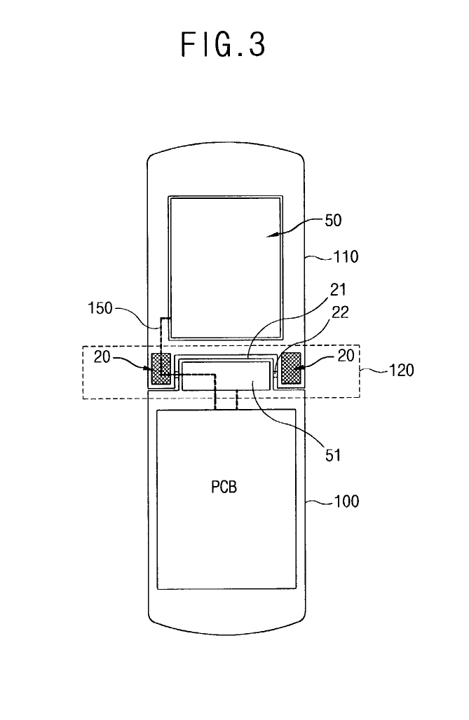

FIG. 3 is a plan view of a mobile terminal in accordance with an embodiment of the invention. As shown in FIG. 3, the mobile terminal includes a terminal main body 100, a folder or flap-style cover 110 having a main LCD mounted thereon, and a hinge device 120 which attaches the folder to the main body. The hinge device includes a sub-LCD mounted at a predetermined position thereon as discussed below.

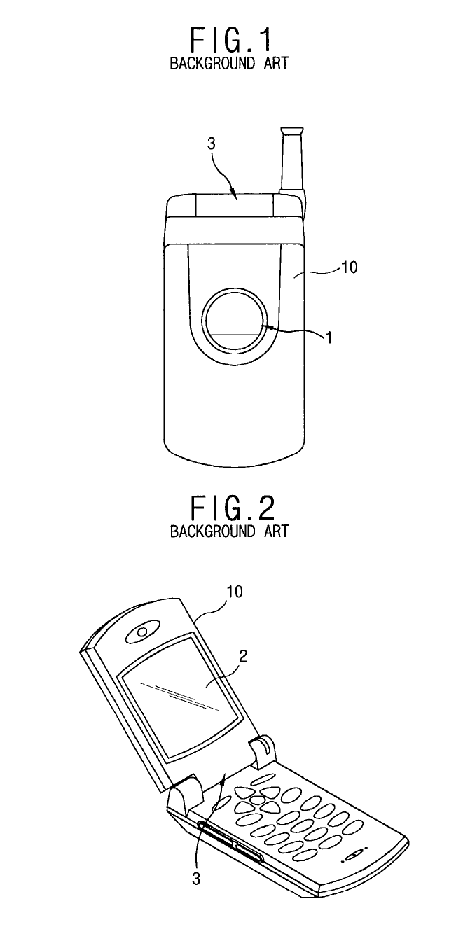

The hinge device 120 includes a hinge 20 mounted on the folder 110, a hinge combining unit 21 having a sub-LCD mounted at a predetermined portion thereon, and a rotational shaft 22 which couples the hinge 20 and the hinge combining unit 21. That is, in one embodiment of the invention, the hinge 20 is positioned on both sides of the folder 110, and the sub-LCD 21 is mounted where the hinge 3 is positioned in the devices of FIGS. 1 and 2.

The hinge 20 is small in size compared to conventional hinges and thus has a weak torque. In order to reinforce the torque, a hinge 20 is mounted on both of the lower sides of the folder 110.

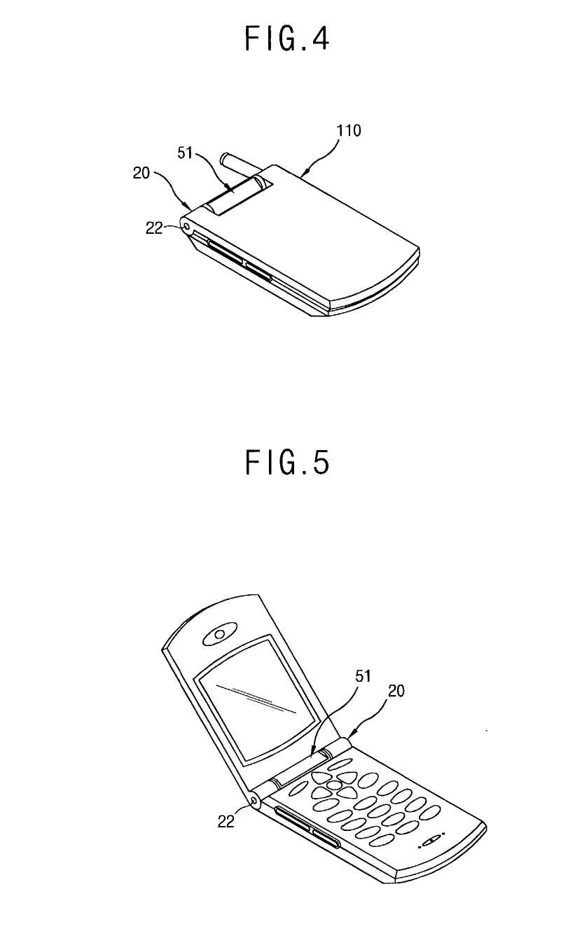

The main and sub-LCDs 50 and 51 are connected to a printed circuit board (PCB) of the main body 100 by a cable 150. Accordingly, when the folder 110 of a mobile terminal with the above-described structure according to the invention, as shown in FIG. 4, is closed, a message and a terminal state can be checked through the sub-LCD 51. Further, when the folder 110 is in an opened state, as shown in FIG. 5, the main LCD 50 and the sub-LCD 51 can be utilized at the same time. For example, while sending a short message using the main LCD 50, the user can check the state of the terminal, such as the receiving sensitivity of the terminal, a residual amount of the battery, the time, and receipt of a new message.

In addition, the invention is not limited to a hinge 20, and the sub-LCD 51 may be mounted for utilization at a hinge of a conventional terminal by providing a hinge combining unit. In this case the hinge device has the same structure as that of the conventional one, and the size of the hinge combining unit is suitably adjusted.

As described above, the mobile terminal according to the invention has many advantages. For example, since the sub-LCD is mounted at the hinge device, a user can check the terminal state (i.e., the receiving sensitivity, the residual amount of the battery, time and receipt of a new message) while using the main LCD. Further, the sub-LCD can be used regardless of whether the folder is opened or closed, so that display efficiency can be maximized. Additionally, since the main LCD and the sub-LCD are mounted at different positions, the thickness of the terminal can be effectively reduced.

The foregoing embodiments and advantages are merely exemplary and are not to be construed as limiting the invention. The present teaching can be readily applied to other types of apparatuses. The description of the invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A mobile terminal, comprising:
a terminal main body;
a folder having a main LCD mounted thereon; and
a hinge device configured to hinge the folder to the terminal main body and having a sub-LCD mounted at a predetermined position thereon.

2. The mobile terminal of claim 1, wherein the sub-LCD is configured so that it is exposed when the folder is opened and when the folder is closed.

3. The mobile terminal of claim 1, wherein the hinge device comprises:
a hinge mounted on the folder;
a hinge combining unit comprising the sub-LCD; and
a rotational shaft for coupling the hinge and the hinge combining unit.

4. The mobile terminal of claim 1, wherein the sub-LCD is mounted on a hinge combining unit of the main body.

5. The mobile terminal of claim 4, wherein the hinge combining unit is positioned at an upper central portion of the main body.

6. The mobile terminal of claim 3, wherein the hinge is positioned on both sides of the folder.

7. A mobile terminal, comprising:
a terminal main body;
a folder with a main LCD mounted thereon; and
a hinge device, wherein the hinge device comprises:
a hinge mounted on the folder;
a hinge combining unit having a sub-LCD; and
a rotational shaft for coupling the hinge and the hinge combining unit.

8. The mobile terminal of claim 7, wherein the sub-LCD is configured so that it is exposed when the folder is opened and when the folder is closed.

9. The mobile terminal of claim 7, wherein the hinge combining unit is positioned at a center of the hinge device.

10. The mobile terminal of claim 7, wherein the hinge is positioned on both sides of the hinge device.

11. The mobile terminal of claim 7, wherein the hinge is positioned at a center of the hinge device.

12. A mobile terminal, comprising:
a main body;
a cover attached to the main body;
a first display mounted on the cover; and
a second display configured to be viewable whether the cover is opened or closed.

13. The mobile terminal of claim 12, wherein the cover is attached to the main body by a hinge device.

14. The mobile terminal of claim 13, wherein the second display is part of the hinge device.

15. The mobile terminal of claim 14, wherein a portion of the hinge device on which the second display is mounted forms part of the main body.

16. The mobile terminal of claim 14, wherein the second display is an LCD.

17. The mobile terminal of claim 13, wherein the hinge device comprises:
a hinge attached to the cover;
a hinge combining unit attached to the main body; and
a rotational shaft configured to couple the hinge combining unit to the hinge.

18. The mobile terminal of claim 17, wherein the second display is attached to the hinge combining unit.

19. The mobile terminal of claim 18, wherein the second display is an LCD.

20. The mobile terminal of claim 18, wherein a portion of the hinge combining unit to which the second display is attached forms part of the main body.

21. The mobile terminal of claim 12, wherein the cover is a flap-style cover.

22. The mobile terminal of claim 21, wherein the first display is mounted on an inside of the cover.

23. The mobile terminal of claim 12, wherein the second display is mounted on the main body.
